(19) United States
(12) Patent Application Publication
(10) Pub. No.: US 2015/0340932 A1
(43) Pub. Date: Nov. 26, 2015

(54) GRAVITY-ASSISTED ROTATING DRIVING APPARATUS

(71) Applicants: Yi-Ping HSU, Kaohsiung City (TW); Chia-Ming HSU, Kaohsiung City (TW); Ting-Chen HSU, Kaohsiung City (TW); Yu-Lien HSU CHU, Kaohsiung City (TW); Kun-Tien WU, Kaohsiung City (TW); Chi-Yuan WU, Kaohsiung City (TW); Ying-Zhun WU, Kaohsiung City (TW)

(72) Inventors: Yi-Ping HSU, Kaohsiung City (TW); Chia-Ming HSU, Kaohsiung City (TW); Ting-Chen HSU, Kaohsiung City (TW); Yu-Lien HSU CHU, Kaohsiung City (TW); Kun-Tien WU, Kaohsiung City (TW); Chi-Yuan WU, Kaohsiung City (TW); Ying-Zhun WU, Kaohsiung City (TW)

(21) Appl. No.: 14/547,443

(22) Filed: Nov. 19, 2014

(30) Foreign Application Priority Data
May 26, 2014 (TW) 103118269

(51) Int. Cl. H02K 11/00

(52) U.S. Cl. CPC H02K 11/0021; H02K 11/0073

(57) ABSTRACT

A gravity-assisted rotating driving apparatus is connected with a horizontal rotating shaft and includes a frame, a pendulum unit, at least one electromagnetic unit, and at least one sensor switch unit. The frame is mounted on the rotating shaft and has an inner space formed inside the frame. The pendulum unit is located in the inner space of the frame and is rotatably mounted on the rotating shaft to form a rotation path. The at least one electromagnetic unit is disposed in the inner space and is arranged along the rotation path. The at least one sensor switch unit is mounted in the frame and is disposed in the inner space. When the pendulum unit passes the adjacent sensor switch unit, the corresponding sensor switch unit controls the corresponding electromagnetic unit to start or stop generating magnetic force and to rotate the pendulum unit.

### BACKGROUND OF THE INVENTION

1. Field of the Invention

The present invention relates to a driving apparatus, and more particularly to a gravity-assisted rotating driving apparatus arranged in a longitudinal direction.

2. Description of Related Art

The conventional generator translates mechanical energy to electrical energy by a driving apparatus, such as a fan by wind power, a waterwheel by hydropower or an internal combustion engine by thermal power.

The conventional driving apparatus work on natural forces to translate the natural forces to electricity power, and have low efficiency in the transformation from mechanical energy to electrical energy.

To overcome the shortcomings of the conventional driving apparatus, the present invention provides a gravity-assisted rotating driving apparatus to mitigate or obviate the aforementioned problems.

### SUMMARY OF THE INVENTION

In order to reach the said invention objective, the present invention provides a gravity-assisted rotating driving apparatus.

The gravity-assisted rotating driving apparatus is connected with a horizontal rotating shaft and includes a frame, a pendulum unit, at least one electromagnetic unit, and at least one sensor switch unit. The frame is mounted on the rotating shaft and has an inner space formed inside the frame. The pendulum unit is located in the inner space of the frame and is rotatably mounted on the rotating shaft to form a rotation path. The at least one electromagnetic unit is disposed in the inner space and is arranged along the rotation path. The at least one sensor switch unit is mounted in the frame and is disposed in the inner space.

When the pendulum unit passes the adjacent sensor switch unit, the corresponding sensor switch unit controls the corresponding electromagnetic unit to start or stop generating magnetic force and to rotate the pendulum unit.

Other objects, advantages, and novel features of the invention will become more apparent from the following detailed description when taken in conjunction with the accompanying drawing.

### BRIEF DESCRIPTION OF THE DRAWINGS

FIG. 1 is a cross-sectional front view of a first embodiment of a gravity-assisted rotating driving apparatus in accordance with the present invention;

FIG. 2 is a cross-sectional side view of the gravity-assisted rotating driving apparatus in FIG. 1;

FIG. 3 shows an operational front view of the gravity-assisted rotating driving apparatus in FIG. 1;

FIG. 4 is a cross-sectional front view of a second embodiment of a gravity-assisted rotating driving apparatus in accordance with the present invention;

FIG. 5 is a perspective view of a third embodiment of a gravity-assisted rotating driving apparatus in accordance with the present invention;

FIG. 6 is a front view of the gravity-assisted rotating driving apparatus in FIG. 5; and

FIG. 7 is a cross-sectional side view of the gravity-assisted rotating driving apparatus in FIG. 5.

### DETAILED DESCRIPTION OF PREFERRED EMBODIMENT

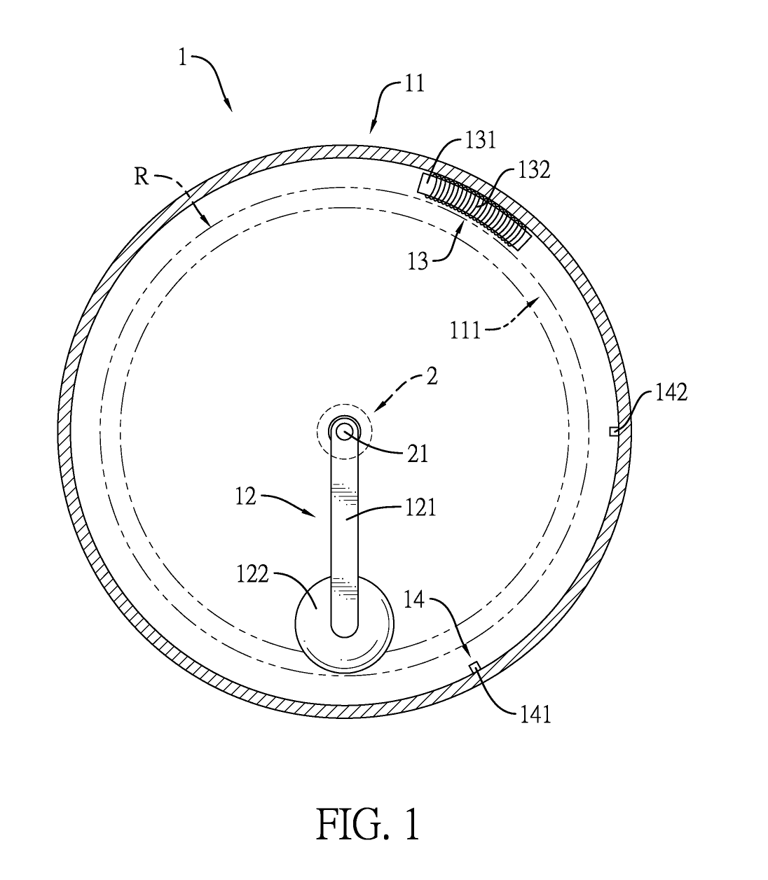

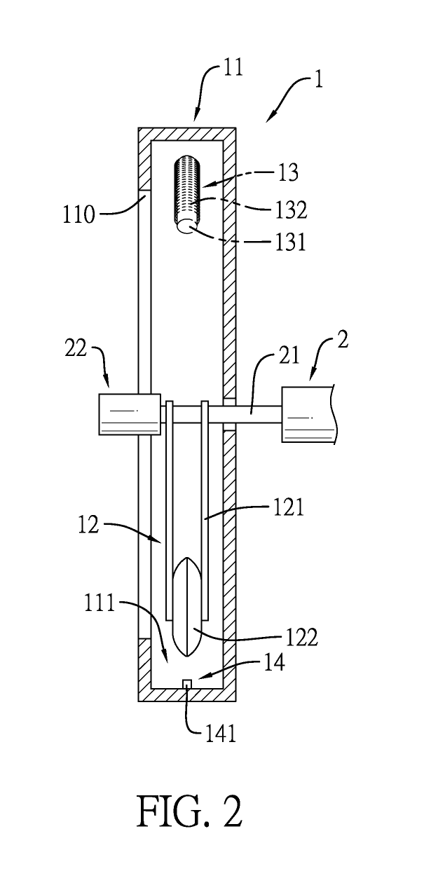

With reference to FIGS. 1 and 2, a first preferred embodiment of a gravity-assisted rotating driving apparatus 1 is connected with an electrical generator 2, which can be a wind power generator, hydraulic power generator, etc.

The electrical generator 2 includes a rotating shaft 21 and a switch device 22. The rotating shaft 21 extends toward a horizontal direction.

The gravity-assisted rotating driving apparatus 1 is longitudinally mounted on the rotating shaft 21 and is connected with the switch device 22.

With reference to FIGS. 1 and 2, the gravity-assisted rotating driving apparatus 1 includes a frame 11, a pendulum unit 12, an electromagnetic unit 13 and a sensor switch unit 14.

The frame 11 is connected with the rotating shaft 21. The frame 11 is wheel-shaped and has a front surface, a center, an inner wall, an opening 110 formed at the center of the front surface, and an inner space 111 formed inside the frame 11 and communicating with the opening 110. The rotating shaft 22 is located at the center of the frame 11.

With reference to FIGS. 1 and 2, the pendulum unit 12 is longitudinally and rotatably mounted on the rotating shaft 21, is located in the inner space 111 of the frame 11 and includes a rotating rod 121 and a magnetic block 122. The rotating rod 121 is elongated and has two ends. One end of the rotating rod 121 is connected with the rotating shaft 21. The magnetic block 122 is mounted on the other end of the rotating rod 121. Preferably, the magnetic block 122 is formed in a disc shape which is thick in a central portion of the magnetic block 122 and thin in a periphery of the magnetic block 122.

The pendulum unit 12 can longitudinally rotate in the frame 11 in a single direction, such as clockwise and anticlockwise. Preferably, the pendulum unit 12 rotates anticlockwise in the frame 11 and forms an anticlockwise rotation path R. When the pendulum unit 12 rotates, the shape of the magnetic blocks 122 can decrease windage and increase the rotating efficiency.

With reference to FIGS. 1 and 2, the electromagnetic unit 13 is disposed in the inner space 111 of the frame 11, is arranged along the rotation path R of the pendulum unit 12, is mounted in the inner wall of the frame 11, and is located adjacent to the magnetic block 122 of the pendulum unit 12. Preferably, the electromagnetic unit 13 includes an electromagnet 131 and a coil 132 coiled around the electromagnet 131. The coil 132 is connected with an external power supply such as a solar battery, to provide electricity to the electromagnet 131 and to drive the electromagnet 131. The electromagnetic unit 13 is controllable to generate magnetism or to stop generating magnetism, when the coil 132 is connected to or disconnected from the power supply. Hence, the magnetic block 122 of the pendulum unit 12 is attracted by the electromagnetic unit 13 to accelerate the rotation of the rotating rod 121.

With reference to FIGS. 1 and 2, the sensor switch unit 14 is mounted on the inner wall of the frame 11 and is disposed in the inner space 111 of the frame 11 and is arranged along the rotation path R of the pendulum unit 12. The sensor switch unit 14 includes a start switcher 141 and a stop switcher 142. Preferably, the start switcher 141 and the stop switcher 142 are both infrared ray sensor switches, are sequentially arranged along the anticlockwise direction and electrically connected with the electromagnetic unit 13. When the rotating rod 121 and the magnetic block 122 pass the start switcher 141 or the stop switcher 142, the electromagnetic unit 13 can be connected to or disconnected from the power supply.

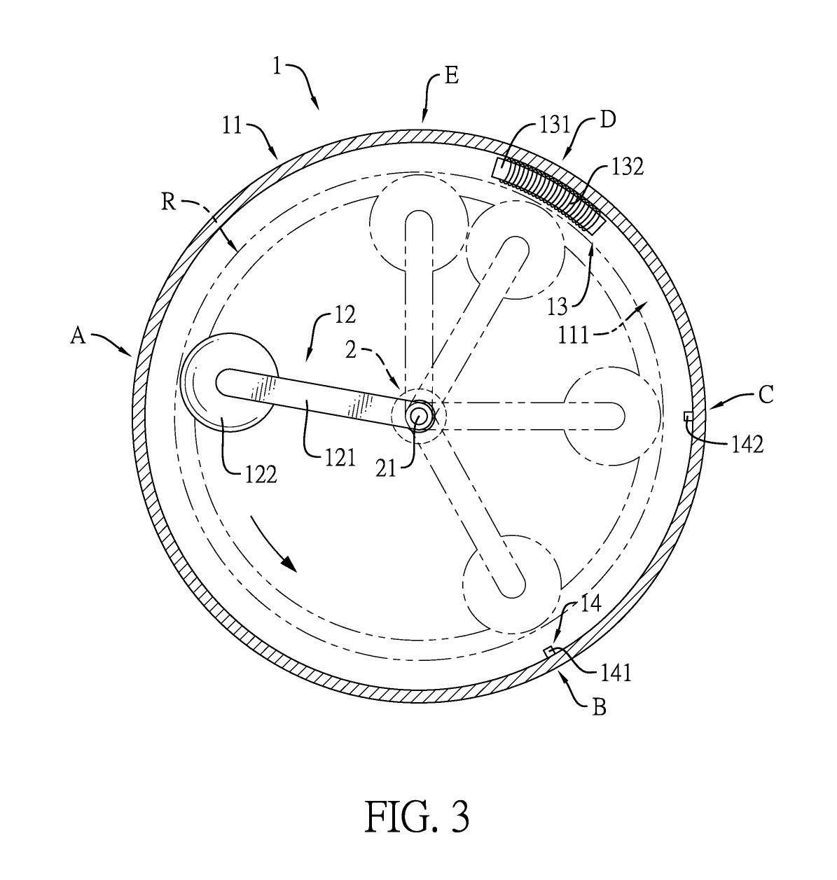

With reference to FIGS. 1 to 3, the switch device 22 drives the rotating shaft 21 and the pendulum unit 12 to rotate away from the electromagnetic unit 13, and raises the pendulum unit 12 up to an initial height A. When the switch device 22 stops and releases the pendulum unit 12, the pendulum unit 12 is dropped down from the initial height A by the gravity and starts rotating.

Since the pendulum unit 12 rotates, the rotating rods 121 pass the start switcher 141(position B) to start the electric connection of the electromagnetic unit 13 and to generate magnetic force to attract the magnetic blocks 122 of the pendulum unit 12. The pendulum unit 12 remains rotating along the rotation path R and passes the stop switcher 142 (position C) that is disconnected from the power supply. The electromagnetic unit 13 will stop generating magnetic force to attract the pendulum unit 12. Meanwhile, the pendulum unit 12 still rotates by the rotational inertia and passes the electromagnetic unit 13 (position D) and a highest point E of the frame 11. After passing the highest point E, the pendulum unit 12 follows the previous movement and is rotated by the gravity, the rotational inertia or the magnetic force to drive the electrical generator 2. Therefore, the electrical generator 2 is driven by the continual rotation of the pendulum unit 12 to efficiently generate electric power.

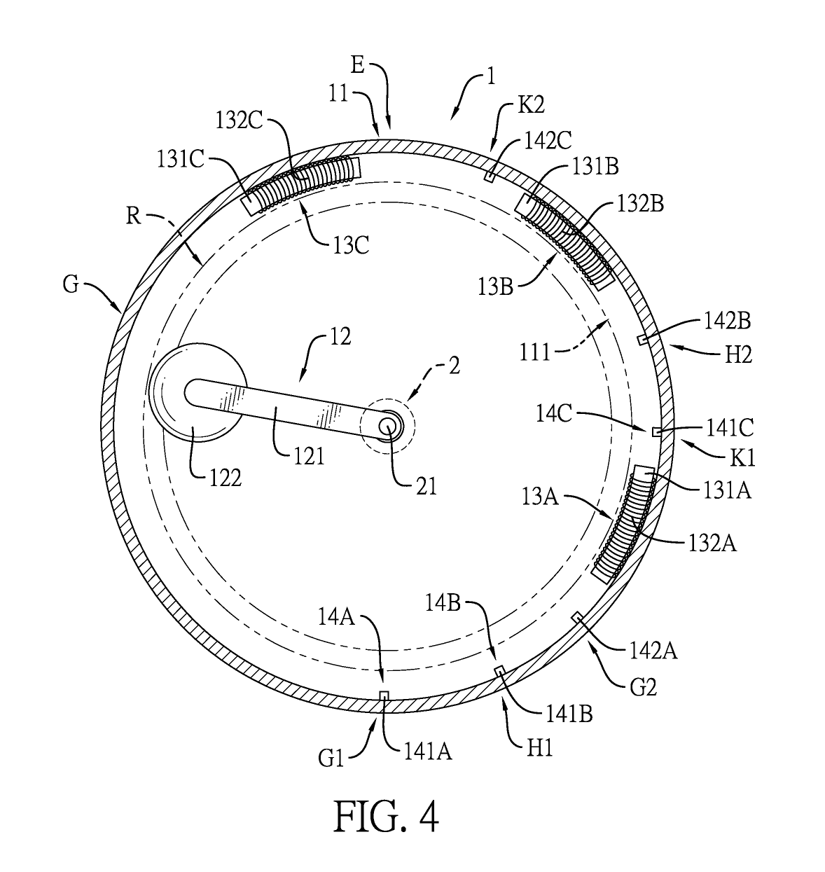

With reference to FIG. 4, in a second preferred embodiment of the gravity-assisted rotating driving apparatus 1 in accordance with the present invention, the elements and effects of the second embodiment are same as those of the first embodiment except the gravity-assisted rotating driving apparatus 1 includes multiple electromagnetic units and multiple sensor switch units. Preferably, the gravity-assisted rotating driving apparatus 1 includes three electromagnetic units 13A, 13B, 13C and three sensor switch units 14A, 14B, 14C. The amount of the electromagnetic units corresponds to the amount of the sensor switch units to increase the magnetic attracting time of the pendulum unit 12 and speeds up the rotational speed of the pendulum unit 12.

With reference to FIG. 4, the electromagnetic units 13A, 13B, 13C and the sensor switch units 14A, 14B, 14C are alternately mounted on the inner wall of the frame 11 and are arranged along the rotation path R of the pendulum unit 12. The sensor switch units 14A, 14B, 14C are respectively electrically connected with the electromagnetic units 13A, 13B, 13C. Each electromagnetic unit 13A, 13B, 13C has an electromagnet 131A, 131B, 131C and a coil 132A, 132B, 132C. Each sensor switch unit 14A, 14B, 14C has a start switcher 141A, 141B, 141C and a stop switcher 142A, 142B, 142C. Each stop switcher 142A, 142B, 142C is located between the corresponding start switcher 141A, 141B, 141C and the corresponding electromagnetic unit 13A, 13B, 13C.

With reference to FIG. 4, the switch device 22 drives the rotating shaft 21 and the pendulum unit 12 to rotate away from the electromagnetic unit 13, and raises the pendulum unit 12 up to an initial height G When the switch device 22 stops and releases the pendulum unit 12, the pendulum unit 12 is dropped down from the initial height G by the gravity and starts rotating.

Since the pendulum unit 12 rotates, the rotating rods 121 pass the start switcher 141A (position G1) to start the electric connection of the electromagnetic unit 13A,13B and to generate magnetic force to attract the magnetic block 122 of the pendulum unit 12. The pendulum unit 12 remains rotating along the rotation path R and passes the stop switcher 142A (position G2) to electrically disconnect from the electromagnetic unit 13A. The electromagnetic unit 13A will stop generating magnetic force to attract the pendulum unit 12. Meanwhile, the pendulum unit 12 still rotates by the rotational inertia and the magnetic force of the electromagnetic unit 13B and passes the start switcher 141C (position K1) to start the electric connection of the electromagnetic unit 13C. When the pendulum unit 12 passes the stop switcher 142B (position H2), the electromagnetic unit 13B will stop generating magnetic force to attract the pendulum unit 12 and to avoid attracting the pendulum unit 12. In the end, the pendulum unit 12 passes the stop switcher 142C (position K2) to stop the electromagnetic unit 13C and comes to the highest point E of the frame 11.

After passing the highest point E, the pendulum unit 12 follows the previous movement and is rotated by the gravity, the rotational inertia or the magnetic force to drive the electrical generator 2.

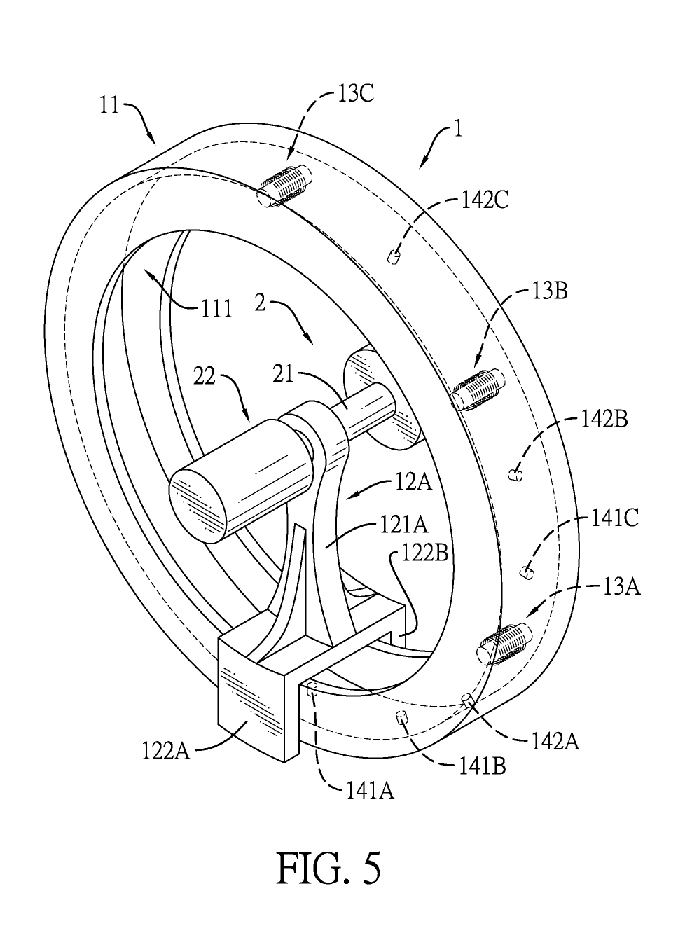

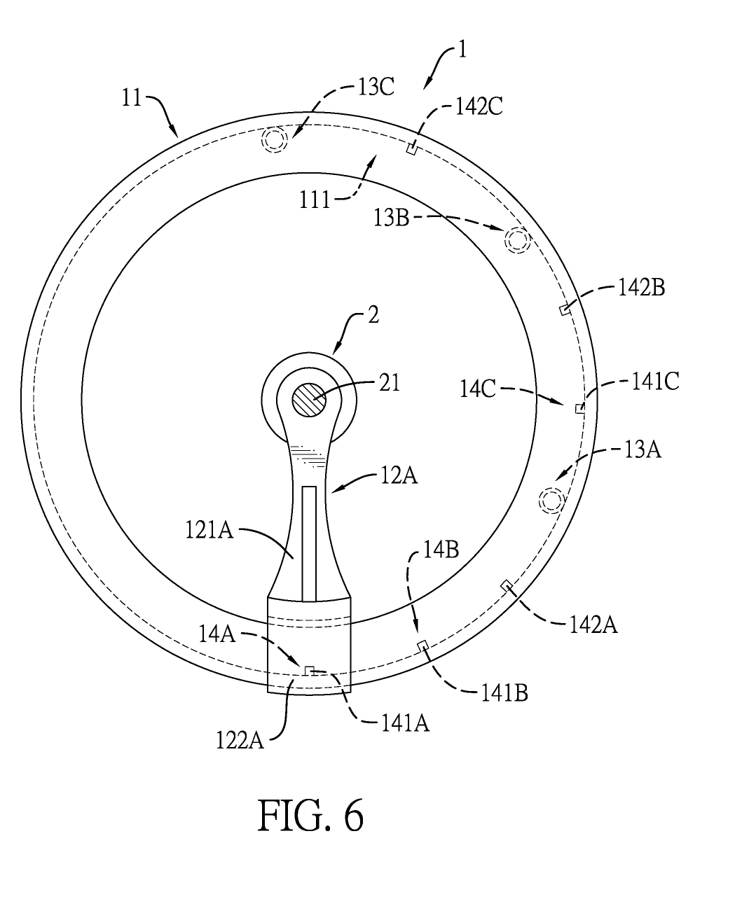

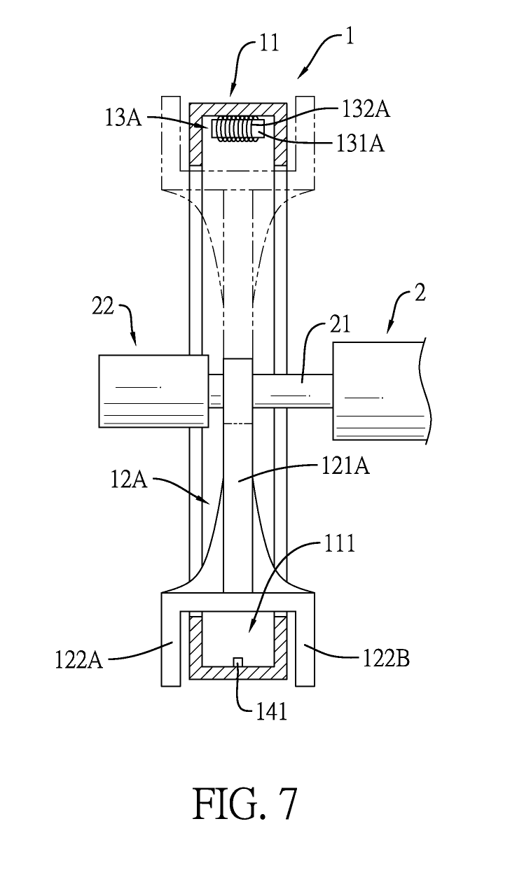

With reference to FIGS. 5 to 7, in a third preferred embodiment of the gravity-assisted rotating driving apparatus 1A in accordance with the present invention, the elements and effects of the second embodiment are same as those of the second embodiment except the pendulum unit 12 A.

The pendulum unit 12 A has a rotating rod 121A and a magnetic block 122. The rotating rod 121A is connected with the rotating shaft 21 and has an end portion. The magnetic block 122 is mounted on the end portions of the rotating rods 121. Preferably, the magnetic block 122 is U-shaped, is disposed around the frame 11 and has two magnetic plates 122A, 122B. The magnetic plates 122A, 122B are parallel to each other, are located respectively at two sides of the frame 11, and are parallel to the two sides of the frame 11.

The electromagnetic units 13 are disposed in the inner space 111 of the frame 11 and are arranged along a periphery of the rotation path R of the pendulum unit 12A. The electromagnets 131 of the electromagnetic units 13 are parallel to the rotating shaft 21. When the electromagnetic units 13 are electrified, the magnetic plates 122A,122B are attracted by the electromagnetic units 13, and the pendulum unit 12 A can be rotated by the magnetic force.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A gravity-assisted rotating driving apparatus comprising:
a rotating shaft extending toward a horizontal direction;
a frame mounted on the rotating shaft and having an inner space formed inside the frame;
a pendulum unit located in the inner space of the frame, longitudinally and rotatably mounted on the rotating shaft to form a rotation path, and including
a rotating rod having two ends, one end of the rotating rod connected with the rotating shaft;
a magnetic block mounted on the other end of the rotating rod;
at least one electromagnetic unit disposed in the inner space of the frame, arranged along the rotation path of the pendulum unit, and mounted in the frame;
at least one sensor switch unit mounted in the frame, disposed in the inner space of the frame, and arranged along the rotation path of the pendulum unit, and the amount of the at least one sensor switch unit corresponding to the amount of the at least one electromagnetic unit;
wherein when the magnetic block of the pendulum unit passes the at least one sensor switch unit, the at least one sensor switch unit sequentially controls the at least one electromagnetic unit to start or to stop generating magnetic force.

2. The gravity-assisted rotating driving apparatus as claimed in claim 1, wherein the driving apparatus includes multiple electromagnetic units and multiple sensor switch units, the amount of the electromagnetic units corresponds to the amount of the sensor switch units, the electromagnetic units and the sensor switch units are alternately mounted in the frame and are arranged along the rotation path of the pendulum unit.

3. The gravity-assisted rotating driving apparatus as claimed in claim 1, wherein
each one of the at least one electromagnetic unit includes an electromagnet and a coil coiled around the electromagnet; and
each one of the at least one sensor switch unit includes a start switcher and a stop switcher, the start switcher and the stop switcher are arranged along the rotation path and are located in front of the at least one electromagnetic unit, and are electrically connected with the at least one electromagnetic unit.

4. The gravity-assisted rotating driving apparatus as claimed in claim 2, wherein
each one of the electromagnetic units includes an electromagnet and a coil coiled around the electromagnet;
each one of the sensor switch units includes a start switcher and a stop switcher, the start switcher and the stop switcher are arranged along the rotation path and are located in front of a corresponding one of the electromagnetic units, and are electrically connected with the corresponding electromagnetic unit.

5. The gravity-assisted rotating driving apparatus as claimed in claim 1, wherein
the magnetic block has two magnetic plates parallel to each other, located respectively at two sides of the frame, and parallel to the two sides of the frame;
each one of the at least one electromagnetic unit includes an electromagnet and a coil coiled around the electromagnet; and
each one of the at least one sensor switch unit includes a start switcher and a stop switcher, the start switcher and the stop switcher are arranged along the rotation path and are located in front of the at least one electromagnetic unit, and are electrically connected with the at least one electromagnetic unit.

6. The gravity-assisted rotating driving apparatus as claimed in claim 5, wherein the driving apparatus includes multiple electromagnetic units and multiple sensor switch units, the amount of the electromagnetic units corresponds to the amount of the sensor switch units, the electromagnetic units and the sensor switch units are alternately mounted in the frame and are arranged along the rotation path of the pendulum unit.
